(19) United States
(12) Patent Application Publication
(10) Pub. No.: US 2009/0280220 A1
(43) Pub. Date: Nov. 12, 2009

(54) Relatively humid food for animals with combined ingredients for instantaneous preparation system

(75) Inventor: Antonio Teixeira de Miranda Neto, Brazil (BR)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: TOTAL ALIMENTOS S/A, Tres Coracoes (BR)

(21) Appl. No.: 12/284,523

(22) Filed: Sep. 23, 2008

(30) Foreign Application Priority Data
May 8, 2008 (BR) PI0801344-6

(51) Int. Cl. A23K 3/00

(52) U.S. Cl. 426/129

(57) ABSTRACT

Food Relatively Humid For Animals With Ingredients Combined For Instantaneous Preparation System, establishing a more affective relationship between the pet and its owner, through an animal food that is close to human food in terms of preparation, aspect and flavor, keeping, however, the nutritional characteristics of animal food necessary to the animal's health, through a combination of components such as protein and/or vegetable particles (feed) or pasta and other extruded particles—obtained by extrusion and/or co-extrusion processes, with balanced nutrients, allied to the complement of meat and vegetables—obtained by dehydration processes. Such combination is obtained following an ideal relation of humidity/water activity obtained through processing, keeping the food preserved in its adequate nutritional and humidity characteristics, for long periods of time, for packaging in packages such as jars, boxes, bags and others, vacuum-sealed or not. After the assembly (mixture) of these elements, a humid animal food with the nutritional ingredients necessary to health is formed, and that, from its packaging until its ingestion, is similar to the procedures for the preparation of human food.

This descriptive report refers to a patent application for an invention of a relatively humid and complete food for pets such as dogs and cats, which by its characteristics, must be prepared and offered by the owner following the procedures similar to the ones used in food product preparation for human consumption.

This food is basically formed by protein and vegetable particles for animals (feed), besides pasta and other extruded particles for animals, obtained by means of industrial extrusion and/or co-extrusion processes, combined to other foods such as meat and derivates, as well as to dehydrated vegetables and fruits obtained by adequate dehydration processes such as lyophilization or other dehydration processes.

The combined food offers the ideal relationship between humidity/water activities, adequate to the condition of the final product preservation, in order that they can keep themselves complete while packed. Therefore, foods are processed with high humidity and low water activity, as well as with low humidity and water activity or any ideal relation that guarantees food stability while it is packed. Because of coefficients relation of humidity/water activity, reached on their manufacturing process, such components keep themselves preserved in the package environment, preserved in their texture, flavor, aroma, color and, mostly, with their original nutritional qualities kept for long periods, protected in the referred package environment, vacuum-sealed or not, in jars and flexible bags and other adequate package elements.

When preparation occurs, done by the pet's owner, the particles (animal food), which can also include extruded pasta and other food particles are mixed to dehydrated food, forming a relatively humid, real and tasty food which can still receive the addition of sauce or powdered palatabilizer and water, and then be offered to the dog, cat, or others. With such procedures the “distances related to human meals are decreased”. However, keeping the nutritional relation necessary for the maintenance of animal health generates “demonstrations of affection and special cares” after the owner's preparation to his pet.

Technique Status

Food industry is the group of industrial activities on which foods, or ingredients to be used on the preparation of these foods are prepared generally in amounts that could be commercialized. Food processing is the name given to methods and techniques group used to transform bulk ingredients into food for human or animal consumption. The food industry uses such processes. The food processing frequently uses harvested or dead components to produce attractive and commercially lucrative food products.

A similar process is used to manufacture animal food, whose segment, as known by engineers and technicians is responsible for an important industrial and technological activity. The main components of animal food are corn, soybeans and proteins of animal origin, which minerals and vitamins are added for adequacy of their nutritional value.

Such mixture is processed in an extruder, taking several forms according to the matrix used, with the food being cut in several shapes of protein particles and/or with addition of vegetables, being able to receive, besides more efficient nutrients, palatabilizing solutions and, finally, packed in sophisticated materials with the objective of promoting its commercialization.

A current tendency is the concern of animal food manufacturers about keeping this important product with satisfactory humidity and palatability from the first bite up to its ingestion, in order that food and health preservation of cats, dogs and others can be stimulated.

Patent PI 0501477-8, entitled “FOOD FOR ANIMALS WITH EXTERNAL AND INTERNAL ADDITION OF PRODUCT FOR PALATABILITY INCREASE”, for example, explains a process developed to keep the flavor and humidity in food for animals. The matter deals with the production of dough that, when expelled on the extruder head, receives, through a coupled device, formed by application needles, the addition of a palatabilizing element under continuous flow. When it passes through the equipment, dough also receives addition of fat and yet another layer of palatabilizing element, forming food in the shape of particles with unique texture, which are tasty during all the deglutition process by the animal.

Anyway, this type of food, under the form of protein particles, is packed in bags, which must be opened so the user removes necessary amount with his hand or with a spoon, places it in a bowl, and then offers it to the animal.

Besides the food under the form of protein and/or vegetables, such as the extruded material explained above, pasty foods for animals are also known in the market, generally packed in metallic cans, whose lids, held by a grip are removed through the rupture of a weakened line conformed around the mouth of the can's body. When the can is open, the owner just removes the paste volume desired to be offered with a spoon and places it over a plate, serving it afterwards.

It is logical that, for a huge majority of owners worldwide, there must always have a relation of care and respect for their pets. Depending on the affinity degree, the particulate food is given with more or less concern by the owner, being only thrown at the floor or offered in a more affective manner.

On this sense, the food package, in a certain form, can make some difference, provided that it is attractive and has a certain similarity with the products consumed by humans, in order to stimulate, instinctively, the owner to offer the food to the animal in a more “humanized” manner.

Patent Objective

The food, objective of this invention patent request, as well as the processes which involve it, traces a relation through which the preparation of the food for the pet—done by its owner—becomes “humanized”, since the animal food is similar to human food also in terms of preparation, aspect and flavor, however, keeping the nutritional characteristics of animal food, necessary to the animal's health.

The system for decreasing the “distance” between the type of food offered to the pet and the “human meals”, is obtained through a combination of components such as protein particles and/or vegetables (feed) and pasta and other similar extruded particles—obtained by extrusion and co-extrusion processes, with balanced nutrients allied to complements like cereal, meat, vegetables and other foods, including fruits—obtained by dehydration processes.

Because of the ideal conditions on the relation humidity/water activity reached on their processing, such components can be packed in one single package, being a jar, box, bag or others, vacuum-sealed or not, keeping themselves preserved in their nutritional characteristics and adequate humidity for long periods. At the moment of preparation, they must be placed in a container, mixed or not, and receive the addition of the palatabilizing element. Such palatabilizing element can be processed under the form of a sauce of adequate consistency packed on the jar lid or in sachets, also able to be packed in powdered form, in this case receiving water, so that it can be mixed to the combined foods.

This way, after the assembly (mixture) of these elements, a humid animal food is formed with the nutritional ingredients necessary for health and that, from their package until their ingestion, is similar to procedures for the preparation of human food, a factor that, naturally, will create a more affective relationship between the owner and his pet.

Superficially explained, the food and the process that involves it will be better detailed through the attached drawings, which can be seen:

FIG. 1—Schematic manufacture presentation of protein particles and/or vegetables for animals, manufactured by extrusion system, in one view, and/or co-extrusion, in another view, on the other side. Such particles, of unique flavor or not, can be combined into two layers, formed from two extruded dough, united between them, as seen on this picture. Foods in three layers can also be obtained, as well as particles in the dough, formed with external and internal addition of palatabilizer and other combinations. By the extrusion or co-extrusion system pasta for animals and other similar extruded particles can also be produced;

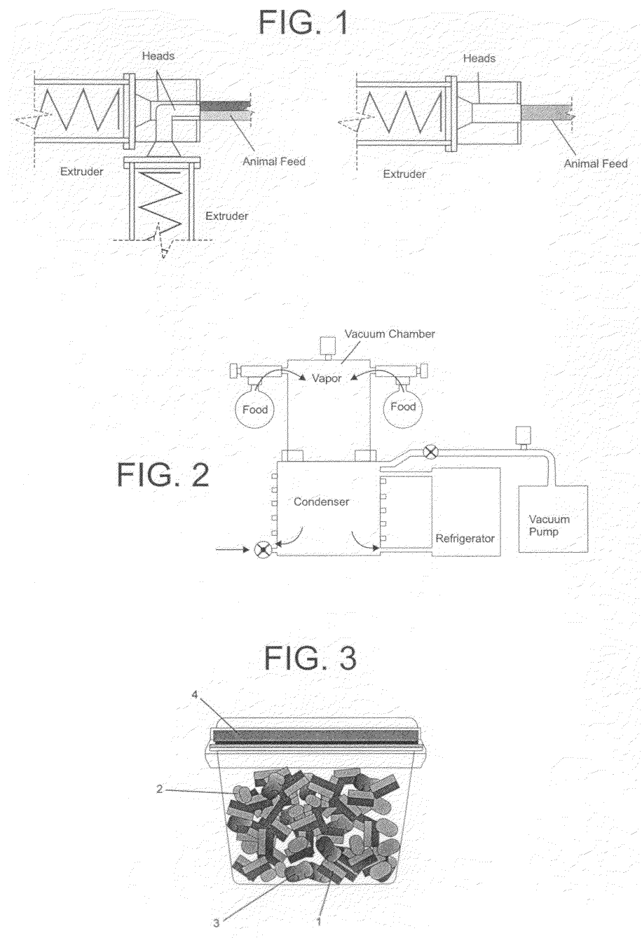

FIG. 2—Schematic presentation of a device for dehydration system, in this case, lyophilization. The equipment is formed by a vacuum chamber which communicates with the compartment storing the food (pre-frozen). Through a refrigerated condenser group, occurs a fast freezing in the vacuum chamber, which, after receiving a strong vacuum application, causes the instantaneous evaporation of the frozen water contained on the product, skipping the liquid state. In this case, dehydration by lyophilization, the water from the frozen product is reduced, removed in the form of gas by vacuum, through a sublimation process. Logically, other dehydration processes can be used;

FIG. 3—High view of a package, keeping the related foods in ideal conditions of humidity/water activity, avoiding deteriorations or alterations which may occur by gain or loss of humidity. The jar shown in the case, can be vacuum packed or not and receives an cup with sauce, which can be also protected by a sealing membrane, or a sachet containing sauce;

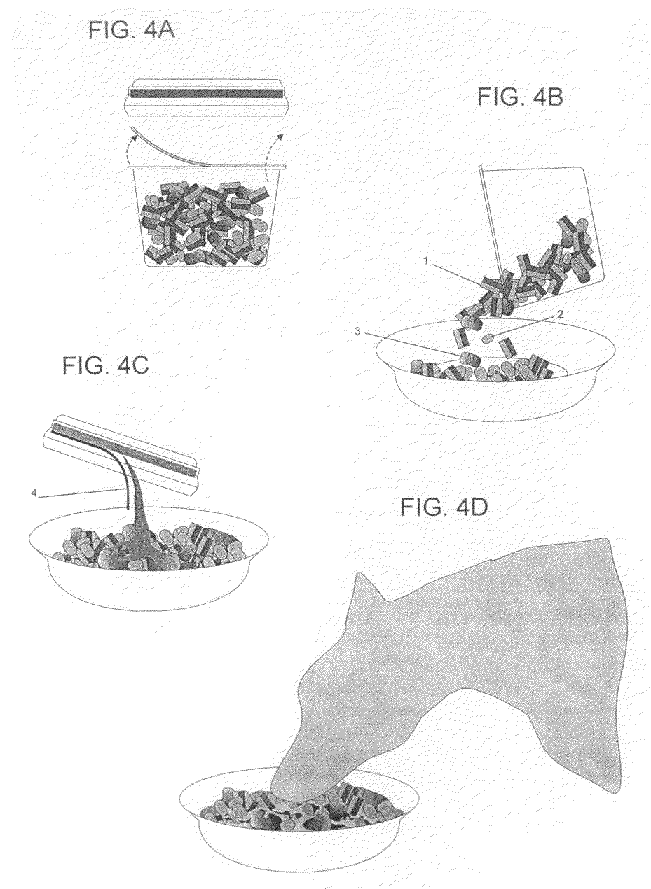

FIG. 4A through 4D—These figures show the preparation sequence until the offering of the food to the pet. The sequence shows the removal of the lid and thermal seal from the jar, followed by the placement of the food on a plate, then opening the lid seal for the addition of sauce over the food combination. After the preparation, in similar procedures to a meal for humans, the food is then offered to the pet.

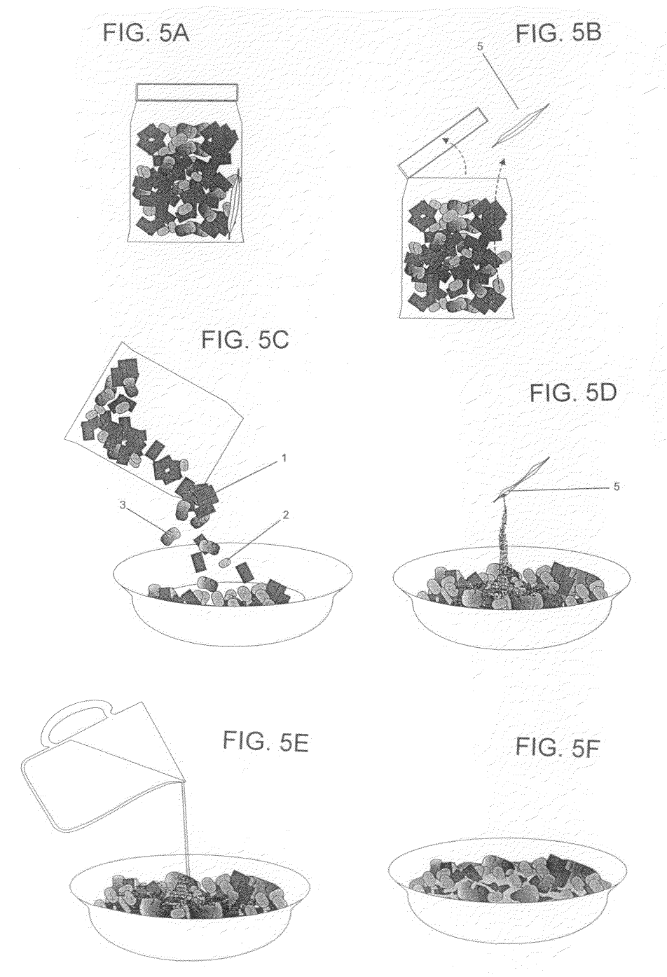

FIG. 5A through 5F—These figures show the food packed in a plastic bag, completed by a sachet containing powdered palatabilizer, to be added with adequate water volume. The sachet may vary in its configuration, having several package formats;

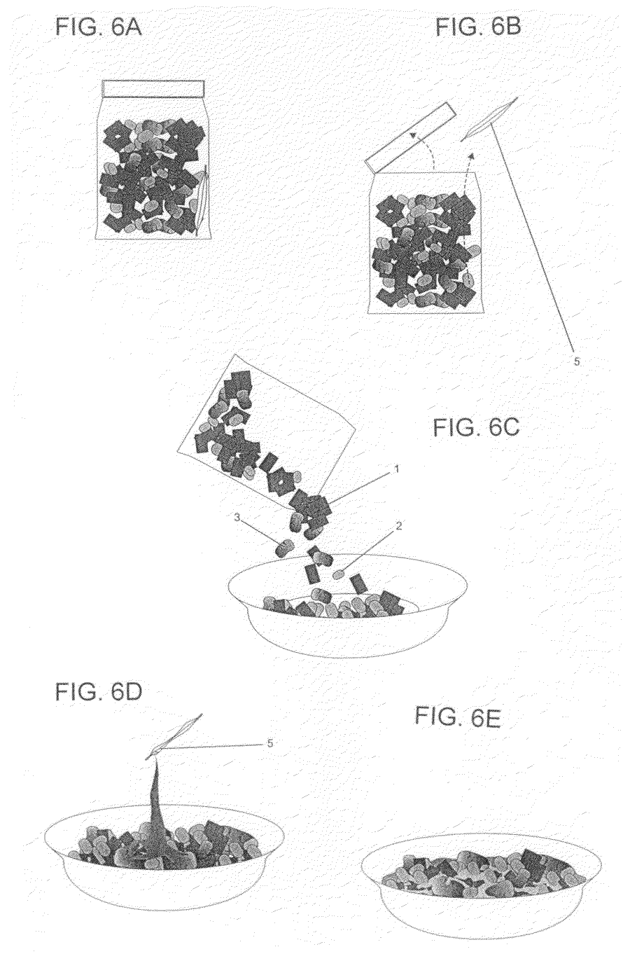

FIG. 6A through 6E—These figures show a sachet containing sauce, being opened for spilling, with no need, in this case, to add water for the preparation of the food.

In conformity with the attached drawings, the “RELATIVELY HUMID FOOD FOR ANIMALS WITH INGREDIENTS COMBINED FOR INSTANTANEOUS PREPARATION SYSTEM”, object of this current invention patent application, constitutes of a combination of foods, such as protein particles and/or vegetables (feed) (1), extruded pasta (2) and other similar extruded particles, coming from extrusion and/or co-extrusion processes, formed in one or more layers, being able to be processed with internal and external addition of palatabilizer.

The particles (1) and the pasta (2) or other extruded particles are obtained from ingredients of vegetal and animal origin such as corn and soybean meal, to which are added proteins and mineral salts, being mixed in a silo, for posterior transference to an extruder, as shown on FIG. 1. Inside of the extruder, through the combination of water and steam, the mixture advances by being pushed by the fuse and is then properly cooked.

When expelled by the matrix, in the extruder head, the dough—protein/vegetable particle or extruded pasta or any other particle, is cut by a knife, in order to obtain its final form.

Therefore, the protein/vegetable particles (1) and extruded pasta and other similar extruded particles (2) are obtained by extrusion process, being able to pass through co-extrusion process to receive two or more distinct layers in their formulation, taste and color, receiving external addition of palatabilizer. The extruder may be coupled to an injection device, with applying needles of palatabilizing element, when the dough exits through the head, in order to fill the inner part of the protein particle, extruded pasta or similar, which may receive the addition of an internal palatabilizing element or not.

The protein/vegetable particles (1) and extruded pasta and other similar particles (2) are completed by dehydrated foods (3) such as meat and its derivatives, as well as vegetable food and fruits, obtained by dehydration process, for example lyophilization and other dehydration processes. Through dehydration process, foods (3) have their water reduced, keeping, however, their nutritional properties.

The process under discussion consists on the adequacy of the ideal conditions of the humidity/water activity coefficients, obtained from the processing of protein/vegetable particles (1), extruded pasta and other similar particles (2) and dehydrated food (3), so that they are kept preserved in their humidity and nutritional characteristics for long periods of time. Such conditions are reached by food processing with high humidity and low water activity, as well as with low humidity and low water activity or any ideal relation between these coefficients, that guarantees the stability of the food while packed.

With such combination of components, in adequate humidity/water activity relation, they are packed in a package, which could be a jar, box, bag or others, vacuum-sealed or not, and the package is completed with palatabilizing element in the form of sauce, with adequate consistency, packed in a seal (4) on the container lid or in powdered form to receive addition of water, or in the form of sauce, packed in sachets (5) or other adequate packages.

Thus, constituted and exposed in the stores, under the form of a “humanized” package, the food, at the moment of its preparation by the pet owner is placed on a plate and mixed or not, being able to receive the addition of the palatabilizing element.

In case of sauce, the lid, when opening, will have its seal (4) removed (FIG. 4) or the sachet will be opened (5) (FIG. 6) for the spillage of the product over the food, whereas in the case of the powdered palatabilizer (FIG. 5), also after the opening of the sachet (5) and spillage of the palatabilizer, food will suffer the addition of water, on the plate, for the instantaneous preparation.

Therefore, after the assembly (mixture) of these elements—protein and/or vegetables particles (feed) (1), extruded pasta and other similar particles (2) and dehydrated foods (3), a plate of humid animal food is formed which, from its packaging until its ingestion, is similar to the procedures for the preparation of human food, a factor that, naturally, will create a more affective relationship between the owner and the pet. The food, however, will keep its nutritional characteristics turned to animal food, for preservation and maintenance of the animal's health.

1. Relatively humid food for animals with combined ingredients for instantaneous preparation system, constituted by a combination of foods, such as protein and/or vegetable particles, pasta or other extruded particles obtained from extrusion and co-extrusion processes, formed in one or more layers, being able to receive internal and external addition of palatabilizer, completed by dehydrated foods, obtained by dehydration, such as meat and derivatives, as well as vegetables and fruits, characterized by being processed in ideal conditions of humidity/water activity relation, in adequate coefficients in order to be packed in packages, vacuum sealed or not and kept preserved through long periods of time in their humidity and nutritional characteristics.

2. Food relatively humid for animals with ingredients combined for instantaneous preparation system, according to claim 1, characterized by the packed food to be completed by palatabilizing element under the form of sauce, of adequate consistency, packed on the container lid.

3. Food relatively humid for animals with ingredients combined for instantaneous preparation system, according to claim 1, characterized by the packed food to be completed by powdered palatabilizing element or sauce, packed in sachets, or another adequate package.

4. Instantaneous preparation system, according to claim 1, obtaining a more affective relationship between the owner and the pet, characterized by, after having mixed the protein/vegetable particles, pasta and other extruded particles and dehydrated foods, forming a plate of humid animal food which, from its package to its ingestion, is similar to procedures for the preparation of human food.
